(19) United States
(12) Patent Application Publication
(10) Pub. No.: US 2024/0393432 A1
(43) Pub. Date: Nov. 28, 2024

(54) DETERMINING A VITAL SIGN FROM A RECEIVED SIGNAL

(71) Applicant: Praesidium, Inc., St. George, UT (US)

(72) Inventors: Seth Campbell, Washington, UT (US); Gian Franco Sacco, Pasadena, CA (US); Panagiotis Giannoulis, Lolodendra (GR)

(73) Assignee: Praesidium, Inc., St. George, UT (US)

(21) Appl. No.: 18/200,570

(22) Filed: May 23, 2023

(51) Int. Cl. G01S 7/41; G01S 7/288

(52) U.S. Cl. CPC G01S 7/411; G01S 7/2883; G01S 7/415

(57) ABSTRACT

An example operation includes one or more of receiving a signal from a sensor proximate a surface in an area, dividing the received signal into a plurality of portions, based on a distance of reflected objects of the area, determining object portions of the plurality of portions related to an animate object, based on movement of the reflected objects, ranking the animate object portions based on an amplitude information over a time window and a periodicity over the time window, and determining an optimal portion of the animate object portions, based on the ranking, wherein the optimal portion is associated with a vital sign of the animate object.

### BACKGROUND

The present document generally pertains to a system that can determine a portion of a received signal from at least one sensor of a person's vital sign on a surface.

### SUMMARY

One example embodiment provides a method that includes one or more of receiving a signal from a sensor proximate a surface in an area, dividing the received signal into a plurality of portions, based on a distance of reflected objects of the area, determining object portions of the plurality of portions related to an animate object, based on movement of the reflected objects, ranking the animate object portions based on an amplitude information over a time window and a periodicity over the time window, and determining an optimal portion of the animate object portions, based on the ranking, wherein the optimal portion is associated with a vital sign of the animate object.

Another example embodiment provides a system that includes a memory communicably coupled to a processor, wherein the processor performs one or more of receive a signal from a sensor proximate a surface in an area, divide the received signal into a plurality of portions, based on a distance of reflected objects of the area, determine object portions of the plurality of portions related to an animate object, based on movement of the reflected objects, rank the animate object portions based on an amplitude information over a time window and a periodicity over the time window, and determine an optimal portion of the animate object portions, based on the rank, wherein the optimal portion is associated with a vital sign of the animate object.

A further example embodiment provides a computer-readable storage medium comprising instructions, that when read by a processor, cause the processor to perform one or more of receiving a signal from a sensor proximate a surface in an area, dividing the received signal into a plurality of portions, based on a distance of reflected objects of the area, determining object portions of the plurality of portions related to an animate object, based on movement of the reflected objects, ranking the animate object portions based on an amplitude information over a time window and a periodicity over the time window, and determining an optimal portion of the animate object portions, based on the ranking, wherein the optimal portion is associated with a vital sign of the animate object.

### BRIEF DESCRIPTION OF THE DRAWINGS

FIG. 1A illustrates an example flowchart, according to example embodiments.

FIG. 1B illustrates an another example flowchart, according to example embodiments.

FIG. 2 illustrates a system, according to example embodiments.

FIG. 3 illustrates a flow diagram according to example embodiments.

FIG. 4 illustrates another flow diagram, according to example embodiments.

FIG. 5 illustrates an example system that supports one or more example embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, computer-readable storage medium, and system, as represented in the attached figures, is not intended to limit the scope of the application as claimed but is merely representative of selected embodiments. Multiple embodiments depicted herein are not intended to limit the scope of the solution. The computer-readable storage medium may be a non-transitory computer-readable medium or a non-transitory computer-readable storage medium.

Communications between the surface (such as a mattress, a seat, etc.) and certain entities, such as remote servers, other surfaces, and local computing devices (e.g., smartphones, personal computers, transport-embedded computers, etc.) may be sent and/or received and processed by one or more ‘components’ which may be hardware, firmware, software or a combination thereof. The components may be part of any of these entities, computing devices, or other computing devices. In one example, consensus decisions related to blockchain transactions may be performed by one or more computing devices or components (which may be any element described and/or depicted herein) associated with the surface and one or more of the components outside or at a remote location from the surface.

The instant features, structures, or characteristics described in this specification may be combined in any suitable manner in one or more embodiments. For example, the usage of the phrases “example embodiments,” “some embodiments,” or another similar language throughout this specification refers to the fact that a particular feature, structure, or characteristic described in connection with the embodiment may be included in at least one example. Thus, appearances of the phrases “example embodiments,” “in some embodiments,” “in other embodiments,” or other similar language throughout this specification do not necessarily all refer to the same group of embodiments. The described features, structures, or characteristics may be combined in any suitable manner in one or more embodiments. In the diagrams, any connection between elements can permit one-way and/or two-way communication, even if the depicted connection is a one-way or two-way arrow.

The example embodiments described herein are directed to a system that can determine a portion of a received signal from at least one sensor of a person's vital sign on a surface. At least one sensor, such as radar, is placed near the surface. The surface may be a mattress, a chair, or any surface where a person normally sits or lays down. Data from the at least one sensor is sent to a processor that analyzes the received data. The analysis of the data includes differentiating between an animate (alive or having life) object on the surface from inanimate (not alive, especially not in the manner of animals and humans.) objects and determining the portion of the data related to a vital sign or heart rate of the animate object. Animate objects could be a human being or an animal, such as a collar for a dog or cat.

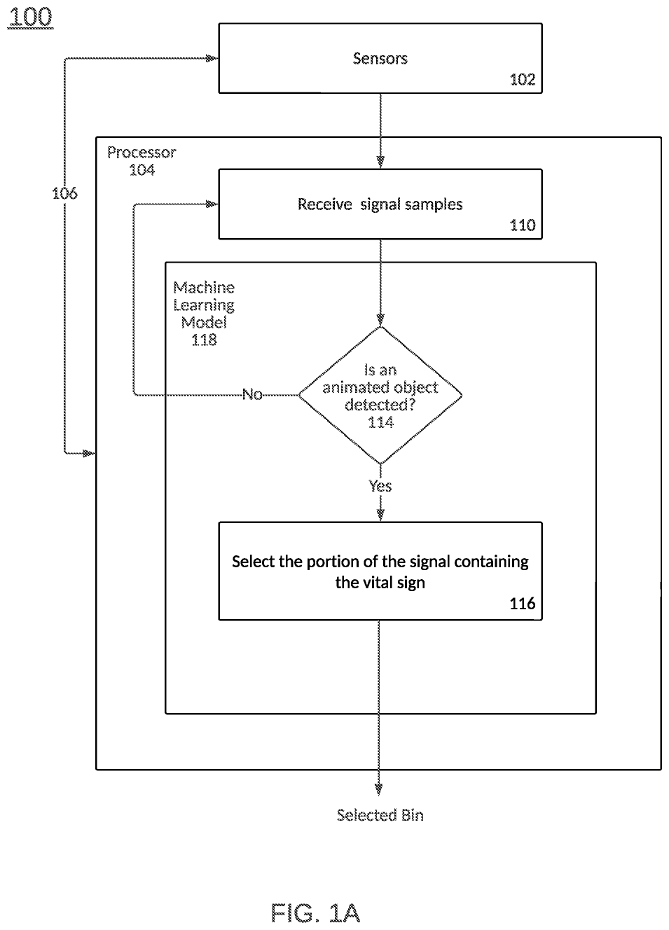

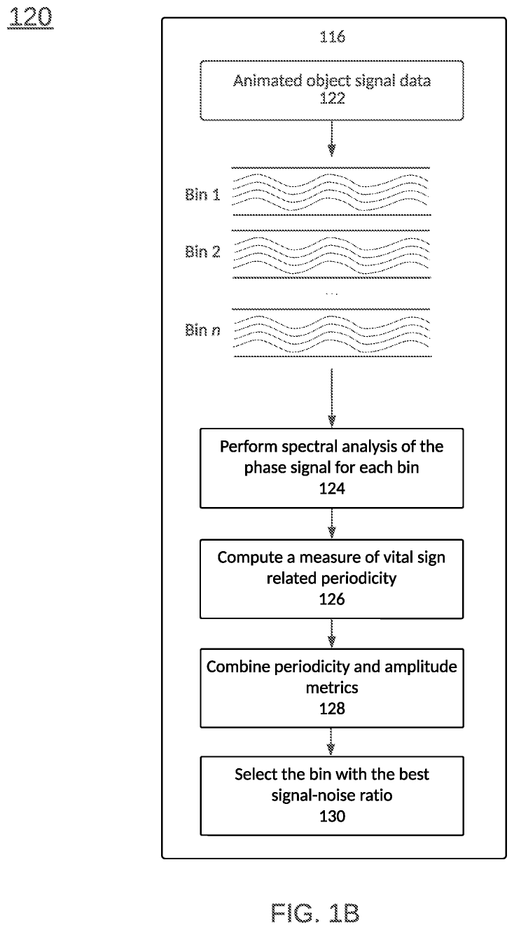

FIG. 1A illustrates a flowchart 100 for determining a vital sign of an animate object on a surface from a received signal, according to various embodiments. At least one sensor 102 collects data and provides samples to a processor 104. The at least one sensor 102 may contain a transmitter and/or a transceiver that allows data to be sent and/or received and stored. Sensors 102 may also be in a device, such as a mobile device. The data from the at least one sensor 102 may be time-ordered sets of data in-phase and/or quadrature data samples. The at least one 102 may be a frequency-modulated continuous wave (FMCW) radar, which sends a frequency-modulated electromagnetic wave. The received signal 110 contains information on all the objects that reflected the radar wave of the sensors 102 at a distance. The modulation of the signal allows for the detection of objects at different distances by providing a quantization of the distance covered by the received signals 102. The quantization size depends on the radar's bandwidth and can be as small as 4 cm, herein referred to as a bin. The received signal is divided into these bins, wherein each bin contains the reflections of all the objects at a distance. One object (for instance, a human body) would occupy several adjacent bins.

The sensors 102 may penetrate many materials, including walls, cushions, pillows, etc., and can be positioned anywhere near the surface. For example, for a surface such as a bed, the sensors 102 could be below the surface, such as on or near the floor, above the surface, attached to the ceiling or the wall, or on the side of the surface, like a nightstand. A person on the surface could be seated or lying down on the surface. For example, the at least one sensor 102 may be on a surface of a seat such as a sofa cushion. The sensor 102 may detect movements on the seat cushion, such as the animate object on the seat cushion. The movements may be related to the animate object moving, twisting, readjusting, and the like. In another example, the movements of the animate object may be related to a detection of a vital sign, such as the breathing and/or heart rate of the animate object. The sensor 102 may be placed at a height in the seat cushion of the surface nearest to where the heartbeat and/or breathing movement of an animate object on the surface, such as when the animate object is seated on the surface, thereby able to more easily detect the breathing movement of a chest of the animate object when seated.

Data from the at least one sensor 102 may be received by one or more processors 104 wherein the sensor 102 and the processors 104 are communicatively coupled to one another. The processor 104 may be a Central Processing Unit (CPU) or Microcontroller Unit (MCU). The processors 104 may be in or proximate the surface. Communication between the at least one sensor 102 and the processors 104 performing the analysis may be through wired or wireless communication, such as Bluetooth, Wi-Fi, a Local Area Network (LAN), a Wide Area Network (WAN), or the like. In another implementation, the processor 104 may send data via wired or wireless communication (e.g., WIFI, Bluetooth, USB cable, ethernet cable, and the like) received by another processor, such as a processor associated with a server, wherein the server may process the received data.

The received data 110 is analyzed by the processor 104 to discriminate between animate and inanimate objects 114 in the received data 110. A machine learning model 118 may be utilized in the processor for the analysis of the received data 110 and may be based on a Convolutional Neural Network-based model (CNN), a network architecture for deep learning. Other topologies may be used in other implementations, such as a Transformer Network, a Recurrent Neural Network, or a Fully Connected Neural Network. The machine learning model 118 may be trained by combining multiple datasets of the received signal with different modalities using different loss functions at different stages or combinations of them.

In one embodiment, the at least one sensor 102 (e.g., an FMCW radar) sends a frequency-modulated electromagnetic wave received by a processor 104. The received signal contains information on all the objects that reflected the radar wave. The modulation of the signal allows for the detection of objects at different distances by quantizing the distance covered by the signal. The quantization's size depends on the radar's bandwidth and can be as small as 4 cm. Each quantization (referred to herein as a bin) contains the reflections of all the objects at a distance. One object (e.g., a human body) might occupy several adjacent bins. To detect if a surface (such as a bed) is occupied, one cannot depend on simply observing large amplitudes of the return signal since the surface is often a strong reflector and might hide the signal of the animate object.

The received data from the sensors 102 may be analyzed for the object's movement. Information associated with large-scale movements (body movements) or small-scale movements (e.g., respiration) is contained in the phase and magnitude of the signal extracted from each bin over time. When the object (e.g., a person) moves on the surface, the person's movement will be much greater than the movement of one or more of the surface and the frame of the surface. This movement may be used to determine the object on the surface. As indicated by the received sensors 102 data, the movement may also be the movement of the person breathing on the surface. The movement may be a movement of a person's chest on the surface, such as a movement up and down. In such a scenario, the movement of the person breathing on the surface will be greater than the movement of the surface and the movement of the frame of the surface.

The algorithm takes as input the time series from different bins of the phase and/or magnitude (i.e., the phase and/or amplitude over a predefined number of time steps). It outputs the decision of the presence or not of an animate object for the given time window. In another example, the location and/or optimal bin is output, or the location/bin that contains the vital sign of an animate object. The network is trained in a way that allows the algorithm to detect animate objects regardless of the existence of other inanimate reflective objects in their proximity. It can also detect animate objects in the absence of motion and even during the absence of respiration (heart beating is enough for detection). Also, the area examined for an animate object can be defined by modifying the set of bins considered.

If an animate object is not detected 114, additional received signals 110 from the sensors 102 are analyzed. If an animate object is detected 114, the portion of the received signal 110 is further analyzed to determine a vital sign 116. The portion of the received signal may be the portion of the signal indicating the vital sign at the best Signal-Noise-Ratio (SRN) 116.

In one implementation, the sensors 102 are always on, collecting data on the surface. In another implementation, the sensors 102 may collect data at an interval, although the sensors 102 may check for presence at given intervals when no object is detected. When an object is detected, the intervals become shorter to detect changes in an object on the surface (e.g., the breathing of a person), as there is a need to check more frequently to avoid missing any subtle changes on the surface. Communication 106 may occur between the processor 104 and the sensors 102, such that the processor 104 may send (via a transmitter or transceiver) a message to the sensors 102 with a modified interval to collect data. Once an object is detected on the surface, the processing for the optimal bin selection begins 116. The object does not have to lie on the surface but only occupy the surface. For example, the object may be sitting on the surface.

The sensors 102 may probe different distances. When the sensors 102 are placed under the surface, data from the sensors 102 received 110 by the processor 104 may initially reflect the bed frame or the bottom of the surface, which will have a strong reflection. If an animate object (such as a person) is lying down on the surface, the object reflects the signal since a person consists mostly of water. The reflection of the person will not be as strong as the reflection of the surface/frame, which is made of hard material. The main difference is that the animate object will have some periodic motion in a certain frequency range, such as 0.2 to 2.4 Hz), which is typical of a vital sign (e.g., breathing rate). The ratio between the energy in the vital range and the rest of the range may determine if an animate object is present at the distance. Still, a fraction of the reflection data will indicate a vital region of the object, which the instant solution concentrates on, referenced herein as the vital sign bin of the received signal.

A prediction of the vital sign may be output by the processor, based on the analysis of the signal in the selected vital sign bin. In another embodiment, the unnormalized probability distribution of the vital sign is determined, and finally, the actual value of the vital sign may be output.

The sensors 102 may be placed anywhere proximate the surface, and the processor 104, receiving the data from the sensors 102 may determine the vital portions of an animate object on the surface 116. Supposing one sensor 102 is placed above or below the surface. When the animate object on the surface breathes, the chest of the object will move up and down, therefore allowing the phase and amplitude of the data from the received sensor 102 to detect the movement. When a sensor 102 is placed at an angle to the animate object, such as on a wall or on a base of the surface frame, the data is less optimal. Yet, determining the object's vitals over a period of time, such as 30 minutes, is possible. The instant solution is agnostic to the position of the sensors 102 and the position of the animate object on the surface since the vitals of the animate object can be determined in all configurations. As such, sensors 102 can be positioned anywhere proximate to the surface, and the vitals of an animate object on the surface can be determined, such as under a bed, attached to a ceiling, attached to a wall near the bed, or on a nightstand.

In one embodiment, processor 104 can extract the vital sign bin for each object on the surface where multiple human objects are present. To this end, processor 104 exploits the fact that the objects have different distances from the radar (therefore, their vital regions may occupy different bins of the received signal). The multiple objects on the surface may also have different distributions of spectral content in their vital regions (e.g., different heart rates or/and respiration rates). In the current embodiment, the bins related to each of the multiple occupants are clustered, and the vital sign bin selection occurs for each object separately.

The signal information contained in the vital sign bin may be used as the actual vital sign of the occupant on the surface by the instant processor, for example, the blood pressure or heart rate. In another example, a probability may be applied to the value based on the prior external information, such as a heart rate is 75 with a 60% probability and a heart rate of 80 with an 80% probability, wherein the heart rate used is dependent on the respective probability.

The sensors 102 may be only on a wall or other element and may be communicatively coupled to the processor 104. The sensor 102 may also be in one or more connected devices, such as a mobile device which may be associated with an occupant of the surface 152. The sensor 102 (e.g., radar functionality) in the connected device may obtain data on the surface. The connected device may be placed such that the device is pointing at the surface, allowing the radar to collect data on objects on the surface.

In one example, the sensor is integrated into a connected device, such as a mobile device, a wearable device, such as a smartwatch, and the like. The connected device may be associated with an occupant of the surface and may receive the data from all of the sensors 102. A processor associated with that connected device analyzes the received data. The connected device may be with the occupant; therefore, the sensor integrated into the device can sense movements and report the collected data to the one or more instant processors. The connected device, and henceforth the sensor on the device, will usually be with the occupant associated with the device. The processor in the connected device may determine the movements of the occupant, such as normal movements associated with how the occupant normally moves. When the occupant's movements are outside of the normal movements, the processor may determine an outlaying situation and one or more of notify the occupant of the situation that is not normal, initiate emergency communication, and the like.

FIG. 1B illustrates another flowchart 120 for determining the vital sign from a received signal. The flowchart provides additional details for selecting the portion of the signal containing the vital sign 116 in FIG. 1A. To determine the vitals of the animate object 116, the processor 104, analyzing the received animate object data 122 from the sensors 102, considers both the phase and the amplitude signals obtained from each bin. The used amplitude of the received signal may be used as an average amplitude value over time for each portion. Amplitude information can be an average amplitude value over time for each portion. High amplitude values indicate strong reflections, while periodic patterns with vital-sign-related frequencies in the phase signal indicate vital-sign presence. Since vital signs such as heart rate and respiration are almost periodic, the algorithm performs spectral analysis of the phase signal for each selected bin 124 and subsequently computes a measure of vital sign-related periodicity 126. By combining periodicity and amplitude metrics 128, the processor 104 selects a bin (the vital sign bin) containing vital-sign information at the best possible signal-noise ratio (SNR) 130. The optimal bin selection can be updated at a specified rate in another embodiment.

In one embodiment, the periodicity metric is computed by measuring the amount of energy that is contained in the vital-sign frequency range compared to the rest of the frequencies. In one example, the ratio of the amplitudes of the Fast Fourier Transform (FFT) amplitudes in the vital-sign frequency range is used versus the sum of the amplitudes of FFT in the frequencies out of the vital-sign range. The FFT converts a signal into individual spectral components, providing frequency information about the signal. In another embodiment, the squared sum or a difference of sums is used instead of a ratio.

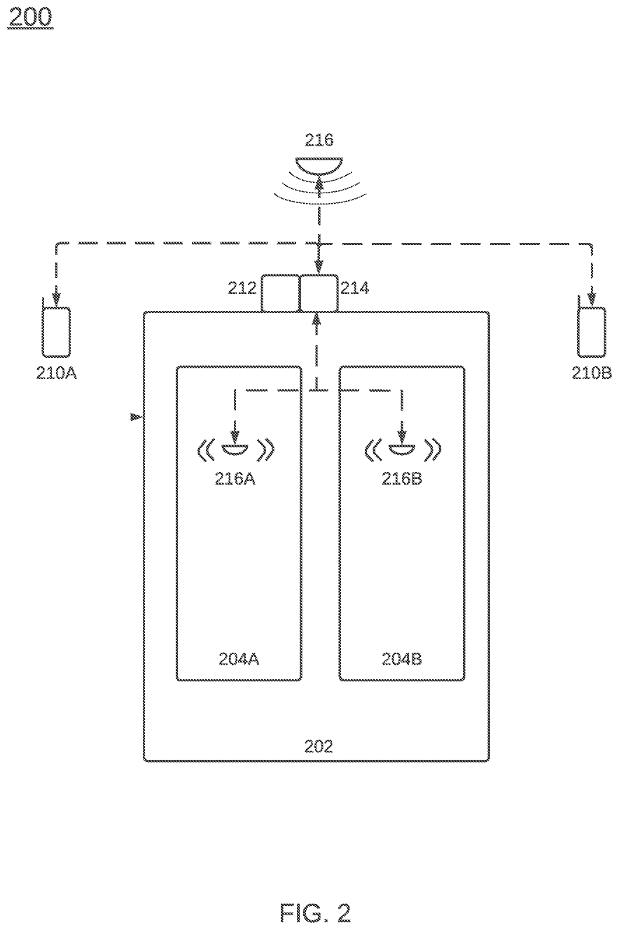

FIG. 2 shows a system 200, according to example embodiments. A surface 202 (e.g., a mattress, a blanket, a floor, a seat cushion, a sofa cushion, a car seat, or the like) is shown, containing two compartments, 204A/204B. One or more compartments in various sizes, shapes, and positions may be integrated into or on the surface. The surface may be permanently attached to another object (such as a base) or may be detachably attached (removable) from a base. The compartments may be filled with one or more substances, such as liquid, air, or any other substance. The compartments may be inflated or deflated, wherein the substance is modified by a device, such as a mechanism 212, which moderates an amount of the substance that flows into and out of the compartments. The mechanism 212 may be triggered to add the substance to one or more of the left compartment 204A and the right compartment 204B. The mechanism 212 may also be triggered to remove the substance from one or more of the left or right compartments. A communication device 214 is communicably coupled to the mechanism 212. It is configured to send and receive messages to and from connected devices 210A/210B that may be associated with one or more users of the surface and the sensors 216/216A/216B and may contain a transceiver, a transmitter, and/or a receiver. The devices 210A/210B may be associated with one or more users of the surface 202. At least one sensor 216 may be present in the system and may be located outside the surface 202 and/or one or more of the compartments 204A and 204B.

For example, the left device 210A is associated with the user that occupies the left side of the surface 202, and the right device is associated with the user that occupies the right side of the surface 202. Implementing the functionality described herein may entirely or partially reside in the surface 202, the compartments 204A/204B, the devices 210A/210B, the mechanism 212, the communication device 214, and/or the sensor 216. In another embodiment, the current solution may fully or partially reside in a server/computer communicably coupled to the system 200, wherein messages between the system 200 and the server/computer route through a network.

The processor 214 receives data indicating a range of bins, wherein each bin is a portion of the signal corresponding to the width of the area covered by the sensor 216/216A/216B. The processor 214 determines that a range of bins contains data on the person's breathing, for example. The instant application, executing on the processor 214, determines the reflection of an object in each bin and ignores other bins in the range of bins. This process may continue until the bin containing a largest portion of the person's moving body is determined, which may indicate breathing. This bin is referred to as the selected bin.

As a portion of the person goes up and down, there is a phase change, as the person's breathing is a rhythmic pattern. Depending on the sensor's location, an object on the surface may be at a horizontal or vertical plane in reference to the sensor. When the object is scanned in a horizontal plane, it is more difficult to determine the person's vitals, as the data received is flat in nature. When the object is scanned in a vertical plane, it may be easier to ascertain a portion of the signal corresponding to the body's movement reflective of the person's breathing.

There are different layers when scanning the surface, such as the bed frame, the mattress, the person's body on the surface, etc., and the received signal is analyzed to ignore reflective portions of the surface, such as the bed frame. Additionally, the bed frame and the mattress will vibrate along with the breathing, but this vibration will be a fraction of the person's movement. Thus this movement will be ignored by the system 200.

In one embodiment, the system is trained to detect animate objects regardless of the existence of other inanimate reflective objects in their proximity. It can also detect living objects in the absence of motion and even during the absence of respiration, where a beating heart is sufficient for detection. The area examined for human presence can be defined by modifying the set of bins considered.

In other configurations, the surface 202 may be small, such as a twin bed, wherein a single compartment 204 and a single sensor 216 are present. The surface 202 may also be larger, such as a king-size bed or a large chair or sofa, wherein more than two compartments 204 and more than two sensors 216 reside.

In different configurations, the sensor(s) 216 may reside in the surface, above the surface, such as on a wall, or proximate the surface 202, such as on a bedside table. In one configuration, the sensors 216 are only in the surface 202, and in another configuration, the sensors 216 are not in the surface 202 but are proximate the surface 202. Yet in another configuration, the sensors 216 are in both the surface and proximate the surface 202. There may be more than two sensors 216 in the surface 204 and/or more than two sensors outside the surface 216, such as proximate the surface 216.

The sensor(s) 216 may be integrated into the surface 202, such as inside a mattress on a bed. The sensor(s) 216 may also be mounted on a flat surface proximate the surface 202, such as on a wall. The sensor(s) 216 may also be present in the surface 202, and the flat surface proximate the surface 202. When sensor(s) 216 are only integrated into the surface 202, movements of animate objects on the surface are detected, such as breathing, heartbeats, or other vital signs. When sensors 216 are only placed proximate the surface 202, the sensors 216 may detect sounds and/or movements of animate objects detected, which may be different from a detection of a vital sign. For example, the sensor(s) 216 may detect sounds of animate objects on the surface, such as moaning, snoring, talking in their sleep, etc. Sensor(s) 216 may also detect large movements of animate objects on the surface 202, such as arm and leg movements, twisting, and/or turning over, such as a movement from laying on the back to laying on the side and/or stomach, etc.

The system 200 may determine a location of where a sound is originated from. For example, when an animate object on the surface 202 is snoring, the sensor (216) may determine the location of the origination of the sound. The sensor(s) 216 may contain acoustic detection, such as sonar, echolocation, etc. Using this detection, the sensor(s) 216 may be able to ascertain the source of the sound.

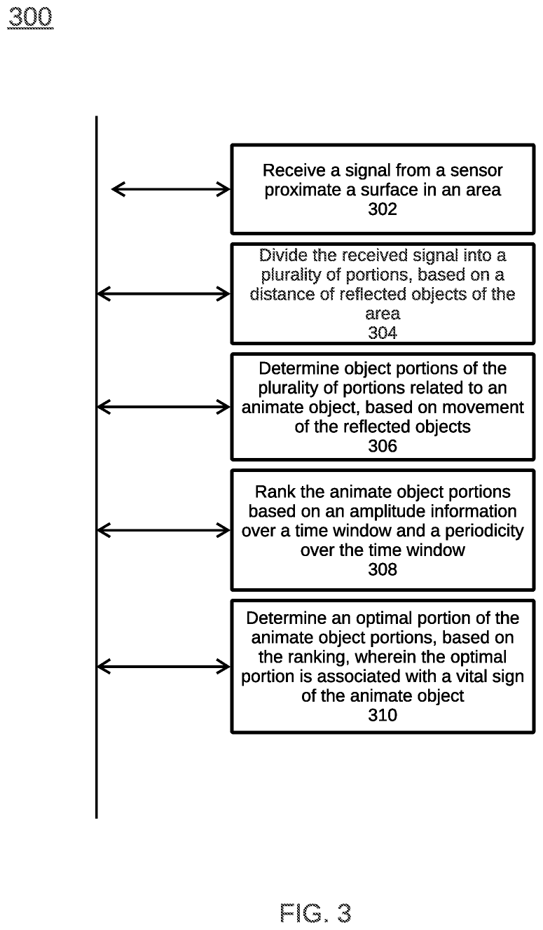

FIG. 3 illustrates a flow diagram 300, according to example embodiments. The solution includes one or more of receiving a signal from a sensor proximate a surface in an area 302, dividing the received signal into a plurality of portions based on a distance of reflected objects of the area 304, determining object portions of the plurality of portions related to an animate object, based on movement of the reflected objects 306, ranking the animate object portions based on an amplitude information over a time window and a periodicity over the time window 308, and determining an optimal portion of the animate object portions, based on the ranking wherein the optimal portion is associated with a vital sign of the animate object 310.

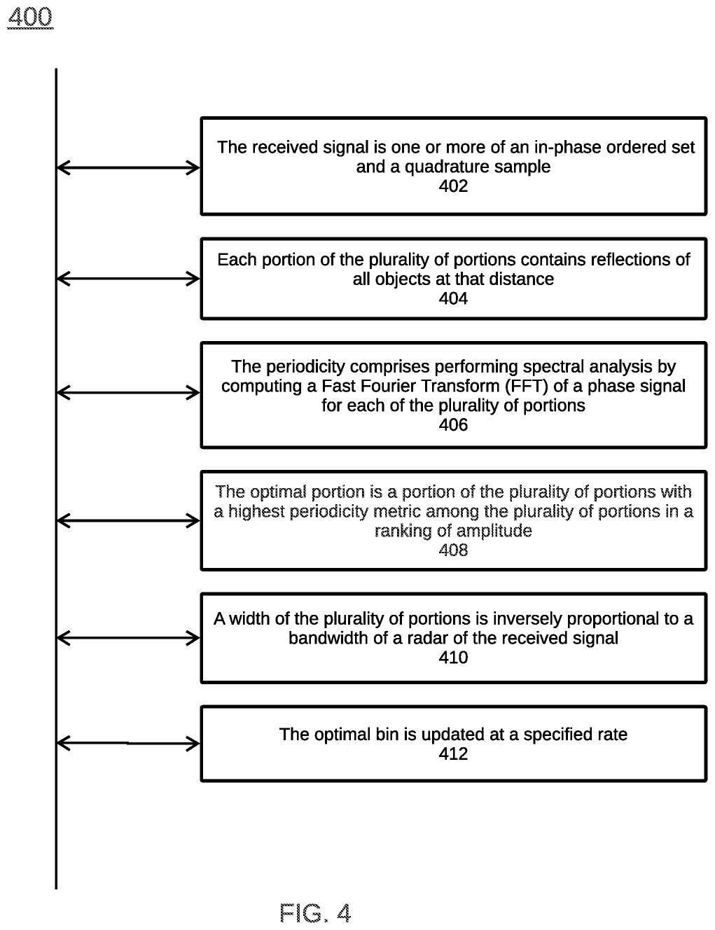

FIG. 4 illustrates another flow diagram 400, according to example embodiments. The solution includes one or more of the received signal being one or more of an in-phase ordered set and a quadrature sample 402, each portion of the plurality of portions contains reflections of all objects at that distance 404, the periodicity comprises performing spectral analysis by computing a Fast Fourier Transform (FFT) of a phase signal for each of the plurality of portions 406, the optimal portion is a portion of the plurality of portions with a highest periodicity metric among the plurality of portions in a ranking of amplitude 408, a width of the plurality of portions is inversely proportional to a bandwidth of a radar of the received signal 410, and the optimal bin is updated at a specified rate 412.

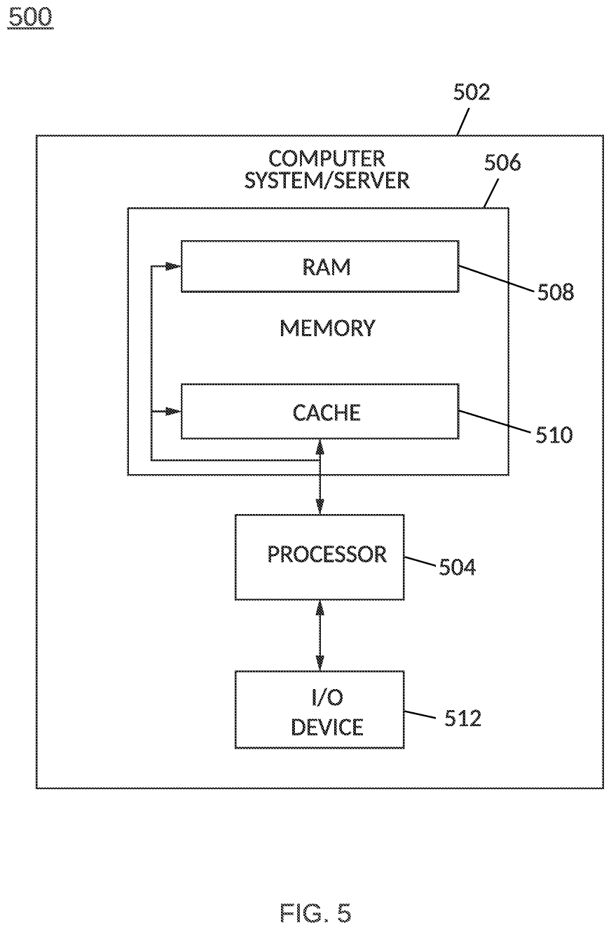

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components. For example, FIG. 5 illustrates an example computer system architecture 500, which may represent or be integrated into any of the above-described components, etc.

FIG. 5 is not intended to suggest any limitation as to the scope of use or functionality of embodiments of the application described herein. Regardless, the computing node 500 can be implemented and/or perform any of the functionality set forth hereinabove.

In computing node 500, a computer system/server 502 is operational with numerous other general or special purpose computing system environments or configurations. Examples of well-known computing systems, environments, and/or configurations that may be suitable for use with computer system/server 502 include but are not limited to, personal computer systems, server computer systems, thin clients, thick clients, hand-held or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Computer system/server 502 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 502 may be practiced in distributed cloud computing environments where tasks are performed by remote processing devices that are linked through a communications network. In a distributed cloud computing environment, program modules may be located in local and remote computer system storage media, including memory storage devices.

As shown in FIG. 5, the computer system/server 502 in cloud computing node 500 is a general-purpose computing device. The components of computer system/server 502 may include but are not limited to, one or more processors or processing units 504, a system memory 506, and a bus that couples various system components, including system memory 506 to processor 504.

The bus represents one or more of several types of bus structures, including a memory bus or memory controller, a peripheral bus, an accelerated graphics port, and a processor or local bus using various bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 502 typically includes various computer system readable media. Such media may be any available media accessible by computer system/server 502, including both volatile and non-volatile media, removable and non-removable media. System memory 506, in one example, implements the flow diagrams of the other figures. The system memory 506 can include computer system readable media in the form of volatile memory, such as random-access memory (RAM) 508 and/or cache memory 510. Computer system/server 502 may further include other removable/non-removable, volatile/non-volatile computer system storage media. By example only, memory 506 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”) and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described herein, memory 506 may include at least one program product having a set (e.g., at least one) of program modules configured to carry out the functions of various embodiments of the application.

Program/utility, having a set (at least one) of program modules, may be stored in memory 506 by way of example, and not limitation, as well as an operating system, one or more application programs, other program modules, and program data. Each of the operating system, one or more application programs, other program modules, and program data or some combination thereof may include an implementation of a networking environment. Program modules generally carry out the functions and/or methodologies of various application embodiments described herein.

As will be appreciated by one skilled in the art, aspects of the present application may be embodied as a system, method, or computer program product. Accordingly, aspects of the present application may take the form of an entirely hardware embodiment, an entire software embodiment (including firmware, resident software, micro-code, etc.), or an embodiment combining software and hardware aspects that may all generally be referred to herein as a “circuit,” “module” or “system.” Furthermore, aspects of the present application may take the form of a computer program product embodied in one or more computer-readable medium(s) having computer-readable program code embodied thereon.

Computer system/server 502 may also communicate with one or more external devices via an I/O device 512 (such as an I/O adapter), which may include a keyboard, a pointing device, a display, a voice recognition module, etc., one or more devices that enable a user to interact with computer system/server 502, and/or any devices (e.g., network card, modem, etc.) that enable computer system/server 502 to communicate with one or more other computing devices. Such communication can occur via I/O interfaces of device 512. Still yet, computer system/server 502 can communicate with one or more networks such as a local area network (LAN), a general wide area network (WAN), and/or a public network (e.g., the Internet) via a network adapter. As depicted, device 512 communicates with the other components of the computer system/server 502 via a bus. It should be understood that although not shown, other hardware and/or software components could be used in conjunction with computer system/server 502. Examples include, but are not limited to: microcode, device drivers, redundant processing units, external disk drive arrays, RAID systems, tape drives, data archival storage systems, etc.

Although an exemplary embodiment of at least one of a system, method, and non-transitory computer-readable medium has been illustrated in the accompanying drawings and described in the foregoing detailed description, it will be understood that the application is not limited to the embodiments disclosed, but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device, and/or via a plurality of protocols. Also, the messages sent or received by any modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone, or any other suitable computing device, or combination of devices. Presenting the above-described functions as being performed by a “system” is not intended to limit the scope of the present application in any way but is intended to provide one example of many embodiments. Indeed, methods, systems, and apparatuses disclosed herein may be implemented in localized and distributed forms consistent with computing technology.

It should be noted that some of the system features described in this specification have been presented as modules to emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations that, when joined logically together, comprise the module and achieve the stated purpose for the module. Further, modules may be stored on a computer-readable medium, such as a hard disk drive, flash device, random access memory (RAM), tape, or any other such medium used to store data.

Indeed, a module of executable code could be a single instruction or many instructions and may even be distributed over several code segments, among different programs, and across several memory devices. Similarly, operational data may be identified and illustrated within modules, embodied in any suitable form, and organized within any suitable type of data structure. The operational data may be collected as a single data set or distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments.

One with ordinary skill in the art will readily understand that the above may be practiced with steps in a different order and/or hardware elements in configurations that are different from those disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only, and the scope of the application is to be defined solely by the appended claims when considered with a full range of equivalents and modifications (e.g., protocols, hardware devices, software platforms, etc.) thereto.

What is claimed:

1. A method, comprising:
receiving a signal from a sensor proximate a surface in an area;
dividing the received signal into a plurality of portions, based on a distance of reflected objects of the area;
determining object portions of the plurality of portions related to an animate object, based on movement of the reflected objects;
ranking the animate object portions based on an amplitude information over a time window and a periodicity over the time window; and
determining an optimal portion of the animate object portions, based on the ranking;
wherein the optimal portion is associated with a vital sign of the animate object.

2. The method of claim 1, wherein the received signal is one or more of an in-phase ordered set and a quadrature sample.

3. The method of claim 1, wherein each portion of the plurality of portions contains reflections of all objects at that distance.

4. The method of claim 1, wherein the periodicity comprises performing spectral analysis by computing a Fast Fourier Transform (FFT) of a phase signal for each of the plurality of portions.

5. The method of claim 1, wherein the optimal portion is a portion of the plurality of portions with a highest periodicity metric among the plurality of portions in a ranking of amplitude.

6. The method of claim 1, wherein a width of the plurality of portions is inversely proportional to a bandwidth of a radar of the received signal.

7. The method of claim 1, wherein the optimal bin is updated at a specified rate.

8. A system, comprising:
a processor; and
a memory, wherein the processor and the memory are communicably coupled, wherein the processor is configured to:
receive a signal from a sensor proximate a surface in an area;
divide the received signal into a plurality of portions, based on a distance of reflected objects of the area;
determine object portions of the plurality of portions related to an animate object, based on movement of the reflected objects;
rank the animate object portions based on an amplitude information over a time window and a periodicity over the time window; and
determine an optimal portion of the animate object portions, based on the ranking;
wherein the optimal portion is associated with a vital sign of the animate object.

9. The system of claim 8, wherein the received signal is one or more of an in-phase ordered set and a quadrature sample.

10. The system of claim 8, wherein each portion of the plurality of portions contains reflections of all objects at that distance.

11. The system of claim 8, wherein the periodicity comprises performing spectral analysis by computing a Fast Fourier Transform (FFT) of a phase signal for each of the plurality of portions.

12. The system of claim 8, wherein the optimal portion is a portion of the plurality of portions with a highest periodicity metric among the plurality of portions in a ranking of amplitude.

13. The system of claim 8, wherein a width of the plurality of portions is inversely proportional to a bandwidth of a radar of the received signal.

14. The system of claim 8, wherein the optimal bin is updated at a specified rate.

15. A computer-readable storage medium comprising instructions, that when read by a processor, cause the processor to perform:
receiving a signal from a sensor proximate a surface in an area;
dividing the received signal into a plurality of portions, based on a distance of reflected objects of the area;
determining object portions of the plurality of portions related to an animate object, based on movement of the reflected objects;
ranking the animate object portions based on an amplitude information over a time window and a periodicity over the time window; and
determining an optimal portion of the animate object portions, based on the ranking;
wherein the optimal portion is associated with a vital sign of the animate object.

16. The computer-readable storage medium of claim 1, wherein the received signal is one or more of an in-phase ordered set and a quadrature sample.

17. The computer-readable storage medium of claim 1, wherein each portion of the plurality of portions contains reflections of all objects at that distance.

18. The computer-readable storage medium of claim 1, wherein the periodicity comprises performing spectral analysis by computing a Fast Fourier Transform (FFT) of a phase signal for each of the plurality of portions.

19. The computer-readable storage medium of claim 1, wherein the optimal portion is a portion of the plurality of portions with a highest periodicity metric among the plurality of portions in a ranking of amplitude.

20. The computer-readable storage medium of claim 1, wherein a width of the plurality of portions is inversely proportional to a bandwidth of a radar of the received signal.
